(19) United States
(12) Patent Application Publication
(10) Pub. No.: US 2026/0197671 A1
(43) Pub. Date: Jul. 9, 2026

(54) APPARATUSES AND METHODS FOR GENERATING TRAINING DATA FOR RADIO-AWARE DIGITAL TWIN

(71) Applicant: Nokia Technologies Oy, Espoo (FI)

(72) Inventors: Karthik UPADHYA, Espoo (FI); Paolo BARACCA, Stuttgart (DE); Andrea BEDIN, Espoo (FI); Martti Johannes MOISIO, Perttula (FI); Mikko Aleksi UUSITALO, Helsinki (FI)

(21) Appl. No.: 18/868,271

(22) PCT Filed: May 23, 2022
(86) PCT No.: PCT/EP2022/063883

§ 371 Date: Nov. 24, 2024

(51) Int. Cl. H04W 24/02; H04W 24/10; H04W 72/0446

(52) U.S. Cl. CPC H04W 24/02; H04W 24/10; H04W 72/0446

(57) ABSTRACT

Example embodiments provide a method to obtain labelled training data for a radio-aware digital twin. The method does not require any reference symbol transmission. Hence, downlink overhead may be reduced. Apparatuses, methods, and computer programs are disclosed.

### TECHNICAL FIELD

The present application generally relates to information technology. In particular, some example embodiments of the present application relate to generating training data for a radio-aware digital twin.

### BACKGROUND

A digital twin (DT) may be a digital or virtual representation of a physical asset or process. Digital twins may be updated based on changes in the physical environment. Digital twins may be modelled by data-driven methods with machine learning.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

Example embodiments enable generating and obtaining labelled training data for a digital twin application. The labelled training data may be generated without requiring dedicated reference symbol transmission for the purpose. Therefore, downlink overhead may be reduced. This may be achieved by the features of the independent claims. Further implementation forms are provided in the dependent claims, the description, and the drawings.

According to a first aspect, a user node is disclosed. The user node may comprise at least one processor; and at least one memory including computer program code; the at least one memory and the computer code configured to, with the at least one processor, cause the apparatus at least to: receive a message from a network node in the radio access network, the message comprising configuration information for at least sampling of a physical downlink channel; perform the sampling on transmissions of the physical downlink channel received over time-frequency resources allocated for the physical downlink channel based on the configuration information; and generate a measurement report comprising one or more samples from the sampled transmissions; and transmit the measurement report to the network node.

According to an example embodiment of the first aspect, the at least one memory and the computer code are configured to, with the at least one processor, cause the user node to: store the one or more samples from the sampled transmissions.

According to an example embodiment of the first aspect, the configuration information comprises at least one of: a frame number and a slot number in the frame number, the frame number and the slot number indicating a slot where the sampling starts, an of index an orthogonal frequency division multiplexing, OFDM, symbol from which the sampling is started in the slot and an index of one or more resource elements over which the sampling is to be performed, a number of OFDM symbols over which the sampling is to be performed, and frequency range or bandwidth over which the sampling is to be performed.

According to an example embodiment of the first aspect, the configuration information comprises a period for repeating the sampling.

According to an example embodiment of the first aspect, the configuration information comprises location and orientation of the user node where the sampling is to be performed.

According to an example embodiment of the first aspect, the configuration information comprises an allocation of uplink resources over a physical uplink channel for the user node to send the measurement report to the network node, the allocation of uplink resources comprising at least one of an uplink bandwidth part, an uplink physical resource block index, an index of an uplink slot and an index of an uplink frame.

According to an example embodiment of the first aspect, the configuration information comprises a number of quantization bits for generating the measurement report.

According to an example embodiment of the first aspect, the configuration information comprises a threshold value indicating if a sample from the sampled transmissions is to be comprised in the measurement report.

According to an example embodiment of the first aspect, the generating the measurement report comprises at least one of: quantizing the one or more samples, source-coding the one or more samples, selecting the one or more samples based on the threshold value, and combining the one or more samples.

According to an example embodiment of the first aspect, the at least one memory and the computer code are configured to, with the at least one processor, cause the user node to: transmit the measurement report based at least on location of the user node in the radio access network and/or radio condition of the radio access network.

According to an example embodiment of the first aspect, the at least one memory and the computer code are configured to, with the at least one processor, cause the user node to: modify trajectory to arrive within an area with good coverage from the network node or in an area of coverage of a dedicated access point or a location set by the network node for performing the sampling.

According to an example embodiment of the first aspect, the measurement report comprises an indication indicative of a location and/or an orientation of the user node.

According to a second aspect, a method carried out by a user node in a radio access network is disclosed. The method comprises: receiving a message from a network node in the radio access network, the message comprising configuration information for at least sampling of a physical downlink channel; performing the sampling on transmissions of the physical downlink channel received over time-frequency resources allocated for the physical downlink channel based on the configuration information; generating a measurement report comprising one or more samples from the sampled transmissions; and transmitting the measurement report to the network node.

According to an example embodiment of the second aspect, the method comprises storing the one or more samples from the sampled transmissions.

According to an example embodiment of the second aspect, the configuration information comprises at least one of: a frame number and a slot number in the frame number, the frame number and the slot number indicating a slot where the sampling starts, an index of an orthogonal frequency division multiplexing, OFDM, symbol from which the sampling is started in the slot and an index of one or more resource elements over which the sampling is to be performed, a number of OFDM symbols over which the sampling is to be performed, and frequency range or bandwidth over which the sampling is to be performed.

According to an example embodiment of the second aspect, the configuration information comprises a period for repeating the sampling.

According to an example embodiment of the second aspect, the configuration information comprises location and orientation of the user node where the sampling is to be performed.

According to an example embodiment of the second aspect, the configuration information comprises an allocation of uplink resources over a physical uplink channel for the user node to send the measurement report to the network node, the allocation of uplink resources comprising at least one of an uplink bandwidth part, an uplink physical resource block index, an index of an uplink slot and an index of an uplink frame.

According to an example embodiment of the second aspect, the configuration information comprises a number of quantization bits for generating the measurement report.

According to an example embodiment of the second aspect, the configuration information comprises a threshold value indicating if a sample from the sampled transmissions is to be comprised in the measurement report.

According to an example embodiment of the second aspect, the generating the measurement report comprises at least one of: quantizing the one or more samples, source-coding the one or more samples, selecting the one or more samples based on the threshold value, and combining the one or more samples.

According to an example embodiment of the second aspect, the method comprises: transmitting the measurement report based at least on location of the user node in the radio access network and/or radio condition of the radio access network.

According to an example embodiment of the second aspect, the method comprises: modifying trajectory to arrive within an area with good coverage from the network node or in an area of coverage of a dedicated access point or a location set by the network node for performing the sampling.

According to an example embodiment of the second aspect, the measurement report comprises an indication indicative of a location and/or an orientation of the user node.

According to a third aspect, a computer program or a computer program product is disclosed. The Computer program (product) may be configured, when executed by a processor, to cause an apparatus at least to perform the following: receiving a message from a network node in a radio access network, the message comprising configuration information for at least sampling of a physical downlink channel; performing the sampling on transmissions of the physical downlink channel received over time-frequency resources allocated for the physical downlink channel based on the configuration information; generating a measurement report comprising one or more samples from the sampled transmissions; and transmitting the measurement report to the network node. The computer program may further comprise instructions for causing the apparatus to perform any example embodiment of the method of the second aspect.

According to a fourth aspect, an apparatus may comprise means for receiving a message from a network node in a radio access network, the message comprising configuration information for at least sampling of a physical downlink channel; means for performing the sampling on transmissions of the physical downlink channel received over time-frequency resources allocated for the physical downlink channel based on the configuration information; means for generating a measurement report comprising one or more samples from the sampled transmissions; and means for transmitting the measurement report to the network node. The apparatus may further comprise means for performing any example embodiment of the method of the second aspect.

According to a fifth aspect, a network node in a radio access network may comprise: at least one processor; and at least one memory including computer program code; the at least one memory and the computer code configured to, with the at least one processor, cause the network node at least to: transmit to a user node in the radio access network, a message comprising configuration information for at least sampling of a physical downlink channel; perform transmissions over the physical downlink channel; receive a measurement report from the user node, the measurement report comprising one or more samples from the transmissions; and determine one or more parameters based on the transmissions and the received measurement report; and transmit the one or more parameters to a digital twin application.

According to an example embodiment of the fifth aspect, the at least one memory and the computer code are configured to, with the at least one processor, cause the network node to: transmit to the user node, the message in response to receiving a request from the digital twin application.

According to an example embodiment of the fifth aspect, the configuration information comprises at least one of: a frame number and a slot number in the frame number, the frame number and the slot number indicating a slot where the sampling starts, an index of a OFDM symbol from which the sampling is started in the slot, an index of one or more resource elements over which the sampling is to be performed, a number of OFDM symbols over which the sampling is to be performed, and frequency range or bandwidth over which the sampling is to be performed.

According to an example embodiment of the fifth aspect, the configuration information comprises a period for repeating the sampling.

According to an example embodiment of the fifth aspect, the configuration information comprises location and orientation of the user node where the sampling is to be performed.

According to an example embodiment of the fifth aspect, the configuration information comprises an allocation of uplink resources over a physical uplink channel for the user node to send the measurement report to the network node, the allocation of uplink resources comprising at least one of an uplink bandwidth part, an uplink physical resource block index, an index of an uplink slot and an index of an uplink frame.

According to an example embodiment of the fifth aspect, the configuration information comprises a number of quantization bits for generating the measurement report.

According to an example embodiment of the fifth aspect, the configuration information comprises a threshold value indicating if a sample from the sampled transmissions is to be comprised in the measurement report.

According to an example embodiment of the fifth aspect, the measurement report comprises an indication indicative of a location and/or an orientation of the user node.

According to a sixth aspect, a method carried out by a network node in a radio access network is disclosed. The method may comprise: transmitting to a user node in the radio access network, a message comprising configuration information for at least sampling of a physical downlink channel; performing transmissions over the physical downlink channel; receiving a measurement report from the user node, the measurement report comprising one or more samples from the transmissions; determining one or more parameters based on the transmissions and the received measurement report; and transmitting the one or more parameters to a digital twin application.

According to an example embodiment of the sixth aspect, the method may comprise: transmitting to the user node, the message in response to receiving a request from the digital twin application.

According to an example embodiment of the sixth aspect, the configuration information comprises at least one of: a frame number and a slot number in the frame number, the frame number and the slot number indicating a slot where the sampling starts, an index of a OFDM symbol from which the sampling is started in the slot, an index of one or more resource elements over which the sampling is to be performed, a number of OFDM symbols over which the sampling is to be performed, and frequency range or bandwidth over which the sampling is to be performed.

According to an example embodiment of the sixth aspect, the configuration information comprises a period for repeating the sampling.

According to an example embodiment of the sixth aspect, the configuration information comprises location and orientation of the user node where the sampling is to be performed.

According to an example embodiment of the sixth aspect, the configuration information comprises an allocation of uplink resources over a physical uplink channel for the user node to send the measurement report to the network node, the allocation of uplink resources comprising at least one of an uplink bandwidth part, an uplink physical resource block index, an index of an uplink slot and an index of an uplink frame.

According to an example embodiment of the sixth aspect, the configuration information comprises a number of quantization bits for generating the measurement report.

According to an example embodiment of the sixth aspect, the configuration information comprises a threshold value indicating if a sample from the sampled transmissions is to be comprised in the measurement report.

According to an example embodiment of the sixth aspect, the measurement report comprises an indication indicative of a location and/or an orientation of the user node.

According to a seventh aspect, a computer program or a computer program product is disclosed. The Computer program (product) may be configured, when executed by a processor, to cause an apparatus at least to perform the following: transmitting to a user node in the radio access network, a message comprising configuration information for at least sampling of a physical downlink channel; performing transmissions over the physical downlink channel; receiving a measurement report from the user node, the measurement report comprising one or more samples from the transmissions; determining one or more parameters based on the transmissions and the received measurement report; and transmitting the one or more parameters to a digital twin application. The computer program may further comprise instructions for causing the apparatus to perform any example embodiment of the method of the sixth aspect.

According to an eighth aspect, an apparatus may comprise means for transmitting to a user node in the radio access network, a message comprising configuration information for at least sampling of a physical downlink channel; performing transmissions over the physical downlink channel; means for receiving a measurement report from the user node, the measurement report comprising one or more samples from the transmissions; means for determining one or more parameters based on the transmissions and the received measurement report; and transmitting the one or more parameters to a digital twin application. The apparatus may further comprise means for performing any example embodiment of the method of the sixth aspect.

Many of the attendant features will be more readily appreciated as they become better understood by reference to the following detailed description considered in connection with the accompanying drawings.

### DESCRIPTION OF THE DRAWINGS

The accompanying drawings, which are included to provide a further understanding of the example embodiments and constitute a part of this specification, illustrate example embodiments and together with the description help to explain the example embodiments. In the drawings:

FIG. 1 illustrates an example of a communication network comprising at least one network node and at least one user node according to an example embodiment;

FIG. 2 illustrates an example of a message sequence chart for generation of training data for a digital twin according to an example embodiment;

FIG. 3 illustrates an example of an apparatus configured to practice one or more example embodiments;

FIG. 4 illustrates an example of a flow chart of a method for performing sampling by a user node to train a digital twin, according to an example embodiment; and

FIG. 5 illustrates an example of a flow chart of a method for obtaining a measurement report by a network node to train a digital twin according to an example embodiment.

Like references are used to designate like parts in the accompanying drawings.

### DETAILED DESCRIPTION

Reference will now be made in detail to example embodiments, examples of which are illustrated in the accompanying drawings. The detailed description provided below in connection with the appended drawings is intended as a description of the present examples and is not intended to represent the only forms in which the present examples may be constructed or utilized. The description sets forth the functions of the example and a possible sequence of operations for constructing and operating the example. However, the same or equivalent functions and sequences may be accomplished by different examples.

Digital twins (DTs) are a digital or a virtual representation of a physical asset, a system or a process. Use of the digital twins may help in predicting problems and finding the optimal solutions, even before the problems really happen. The DT may leverage a wide variety of technologies including internet of things, machine learning and big data to create digital simulation models that may change as the physical entity changes. The DT may constantly learn from the sources connecting to the physical entity, based on historical knowledge and data from other systems, and update itself accordingly in real time. DTs may focus on maintaining a full history and up-to-date information of the physical assets/systems to facilitate intelligent and data-supported decision making. The digital twins may provide feedback on how to optimize operations and enable higher levels of productivity and efficiency.

The DT may, for example, portray the network and users with digital modelling of external environment of network elements and service characteristics. A radio-aware DT refers to a digital representation of a radio propagation environment. The radio-aware DT may have knowledge of the radio network. The knowledge of the radio network may comprise all transmitting and receiving nodes, locations of the nodes and radio capabilities of the nodes. The DT may maintain a database that is called a Radio Environment Map (REM). The REM may have information about radio propagation and/or channel quality in a geographical area of the radio network. The radio network may be divided, for example, into bins of N×M square meters.

Such a DT may map independent variables in a communication system to the signal-to-interference and noise ratio (SINR)/block error rate (BLER) of a communication link between nodes of the communication system. The nodes may comprise, for example, user equipment (UE) and a base station (BS). The independent variables may comprise, for example, interferer locations, orientations, and trajectories, transmit powers, time and frequency resource allocation, and propagation environment characteristics, for example.

Digital twin applications may be used, for example, in fields of manufacturing, automotive, healthcare, and environmental industry. In future factories, at least some of UEs may be machines. The machines may comprise, for example, automated guided vehicles (AGVs), unmanned aerial vehicles (UAVs), drones and/or fixed machines. The trajectories of these UEs are known or can be controlled accurately.

The radio-aware DT may be used to proactively, or based on an intent, perform time-frequency resource allocation, modulation coding scheme (MCS) adaption, decisions on handovers, and the like, by predicting the radio conditions at the UE without requiring explicit measurements or reference symbol transmission. Therefore, the radio-aware DT may enable improving the spectral and energy efficiency of the network.

A radio-aware DT may require an accurate model of the propagation environment. The DT and the REM database may need to be constantly updated to take changes in the environment into account. Some approaches used to model the radio propagation environment, such as ray tracing, may not be accurate as they do not capture all modes of electromagnetic propagation. Further, some approaches, such as finite element methods, may be too computationally intensive to be used in real-time operation. Data-driven methods with machine learning may offer a good trade-off between the modelling accuracy and computational complexity.

Machine learning models for a radio-aware DT may require large amounts of labelled training data that needs to be obtained from measurements. Such data may also be required to keep the REM database updated. Making these measurements may require reference symbols, such as UE-specific demodulation reference symbols (DMRS) or channel state information reference symbols (CSI-RS) to be transmitted which increases the overall overhead. The overhead may become prohibitively large in time-varying propagation environments with a large number of sensor nodes, such as at warehouses or ports, where measurements need to be made regularly.

Further, the AGVs and UAVs, for example, may be equipped with cheap narrow-band RX-only radio frequency (RF) chains for the sole purpose of simultaneously generating measurement data in a wide variety of antenna positions and orientations. Hence, the measurements may be performed in the downlink (DL). Consequently, uplink (UL) measurements (with UL/DL reciprocity at BSs) may not be a viable option to generate labelled training data.

One approach comprises using the UE-specific CSI-RS and/or DMRS transmitted by the network. The UE may then use these reference symbols to perform measurements and send them back to the network. However, this approach requires additional overhead that scales with the number of UEs in the network.

Minimization of drive tests (MDT) is a standardized feature in 3GPP LTE/NR. In MDT, it is possible to make the normal UEs to collect certain key performance indicators (KPIs), such as radio link failures, which may be then reported back to the network. The reporting may comprise position of the UE. This way, an operator may collect useful information of the real performance in a live network. However, this method requires additional reference symbols to be transmitted for measurements.

Analog channel state information (CSI) is a concept where the UE amplifies and forwards the unquantized received observations back to the network. While the concept also has the feature of reference not additional 41 requiring symbol transmissions for updating the DT, the analog symbols that are received at a base station may be corrupted with additional noise and interference. Consequently, the quality of the labelled training data for the DT may be poor.

According to an example embodiment, a method to obtain labelled training data for a DT is provided. Advantageously, an example embodiment may enable reducing the downlink overhead for reference symbol transmission when generating labelled training data for a machine learning model of the radio-propagation environment. The method may comprise compressing the measurement information that is to be sent from the UE to the network. The method may further enable obtaining channel state information at the network from the UE measurements.

As mentioned above, an example embodiment may enable lower DL overhead. When training the machine learning model of a radio-aware DT, large amounts of measurement data may be needed. Hence, transmitting CSI-RS and DMRS for this purpose would increase the DL overhead. For this reason, in the proposed method, the UE may be configured to observe on user or control plane data and transmit the unprocessed or quantized samples back to the network. The received samples may be transmitted along with additional labels, for example the time and frequency location of the resource elements and/or the location and orientation of the UE at the time of receiving the samples. The method does not require dedicated reference symbols to be transmitted in the DL. Since there is no additional DL overhead associated with the method, transmitting raw/quantized samples back to the network enables to quickly generate large amounts of labelled training data for machine learning algorithms. The network then analyses the data that is transmitted back and obtains relevant parameters such as SINR/channel statistics.

An example embodiment may enable higher time-frequency resolution of measurements. In general, CSI-RS or DMRS are limited by how close they can be in time or frequency because transmitting these reference symbols in time or frequency may often increase DL overhead. Consequently, measurements based on reference symbols may have a low resolution. However, since the proposed method relies on sending back samples of the DL user plane data or control plane data to the network, the time-frequency resolution may be as high as a single RE, i.e., 1 sub-carrier spacing in frequency and 1 OFDM symbol duration in time. This enables the DT to learn a high-resolution model of the channel evolution in time and frequency.

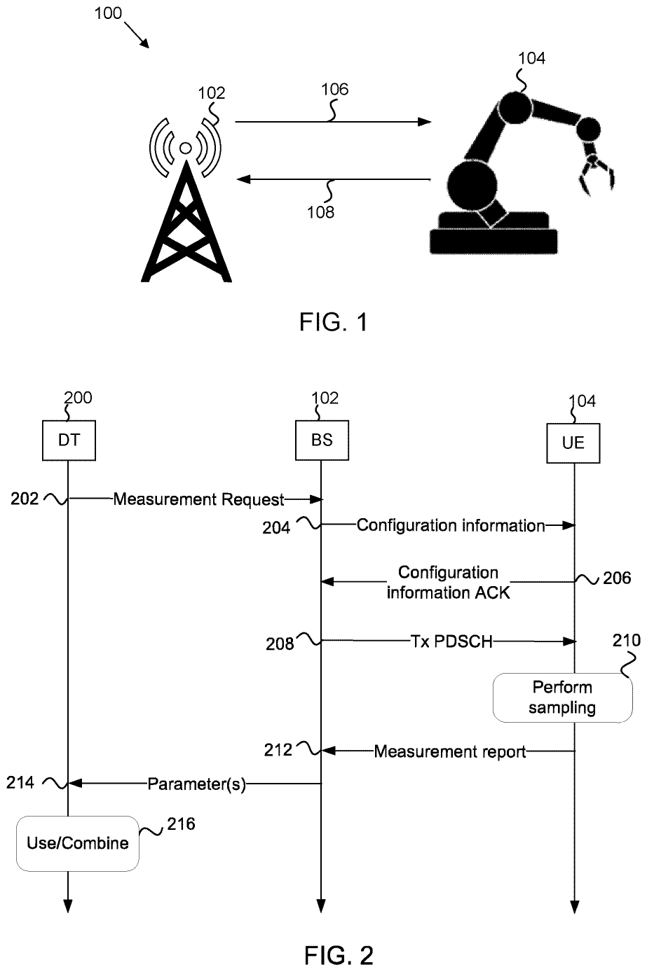

FIG. 1 illustrates an example of a communication network 100 comprising at least one network node and at least one user node. The network nodes may be also referred to as base stations, such as gNBs. The communication network 100 may comprise one or more core network elements, such as for example access and mobility management function (AMF) and/or user plane function (UPF). The communication network 100 may further comprise one or more client nodes, which may be also referred to as user nodes or UE. For example, the communication network 100 may comprise a UE 104. Network elements AMF/UPF and gNB may be generally referred to as network nodes or network devices.

In an embodiment, the UE 104 may be an AGV, a UAV, a drone, or some other mobile measurement platform. In an embodiment, the UE 104 may be any mobile or fixed machine operating, for example, in a factory environment. In an embodiment, the UE 104 may be or comprise a sensor node. The sensor node may be capable of performing some processing, gathering sensory information, location information (e.g. if the sensor node is not fixed at a position), and/or communicating with other connected nodes in the network, such as the base station 102. The UE 104 may communicate with one or more of the base stations via wireless radio channel(s). Communications between UE 104 and BS 102 may be bidirectional. Hence, any of the devices may be configured to operate as a transmitter and/or a receiver.

The base stations and UEs may be configured to communicate with the core network elements over a communication interface, such as for example a control plane interface or a user plane interface. Base stations may also be called radio access network (RAN) nodes and they may be part of a radio access network between the core network and UEs. In general, a base station may comprise any suitable radio access point. In an embodiment, the communication network 100 may comprise one or more access points (APs) which may be, for example, low-range high-bandwidth access points at millimeter wave or THz frequencies.

Although depicted as a single device, a network node may not be a stand-alone device, but for example a distributed computing system coupled to a remote radio head. Various signaling information may be exchanged in the communication network 100 to provide information related to transmission parameters and allocation radio of resources for data transmission. Signaling information may be provided on various levels of a protocol stack.

The communication network 100 may comprise one or more digital twins. The digital twin may be an application running on a computing device. The DT may be configured to accurately model the devices, communication links, operating environment, and/or applications running on the network. The digital twin may be a radio-aware digital twin. In an embodiment, data associated with the DT may be distributed over the network, for example in a cloud or several servers. The other nodes in the communication network may be physical twins which are a basis of the digital model and source of data for the DT. The DT may be a host of data models, historical data of the physical twins, decision support, and/or artificial intelligence, for example. Communication between the DT and other nodes may be bidirectional. The DT and other nodes may be able to exchange data and control commands. The DT may, for example, request for training data from the BS 102 to update a machine labelled learning model of a radio-propagation environment of the network.

In an embodiment, the UE 104 may observe samples based on a configuration provided by the BS 102, and the BS 102 may be configured to provide the samples to the digital twin as labelled training data. The BS 102 may be configured to transmit signals 106 over PDSCH/PDCCH. The UE 104 may be configured to measure samples of the received PDSCH/PDCCH signals, and dispatch one or more of the received PDSCH/PDCCH samples 108 back to the BS 102 over a physical uplink channel.

The communication network 100 may be configured for example in accordance with the 5th Generation digital cellular communication network, as defined by the 3rd Generation Partnership Project (3GPP). In one example, the communication network 100 may operate according to 3GPP 5G-NR. It is however appreciated that example embodiments presented herein are not limited to this example network and may be applied in any present or future wireless or wired communication networks, or combinations thereof, for example other type of cellular networks, short-range wireless networks, broadcast or multicast networks, or the like.

FIG. 2 illustrates an example of a message sequence chart for generating labelled training data of a radio network for a radio-aware DT, according to an example embodiment.

At 202, the digital twin 200 may send a measurement request for a base station 102 to obtain labelled training data.

At 204, the base station 102 may configure measurement resources for the UE 104. In an embodiment, the BS 102 may send time-frequency indexes of PDSCH/PDCCH REs (resource elements) that the UE 104 is expected to observe and send back to the network. BS 102 may therefore send, for example in a message, configuration information for sampling received physical downlink signal(s), represented in this example PDSCH/PDCCH signal(s). The configuration information may indicate the time-frequency resources over which the sampling is performed. BS 102 may send the configuration information in response to receiving the measurement request from DT 200 at 202. In an embodiment, the observed REs may correspond to the PDSCH/PDCCH meant for a different UE. The BS 102 may also allocate uplink resources in the configuration for the UE 104 to send the measurement report, comprising the received samples, back to the BS 102. The BS 102 may be configured to send the configuration information to the UE 104, for example over a physical downlink control channel, such as PDCCH.

In an embodiment, the BS 102 may instruct the UE 104 to periodically sample transmission received over a set of resource elements. The BS 102 may, for example, provide the UE 104 with the individual time-frequency indexes of the REs over which the sampling needs to be performed along with a time-period. The UE 104 may be then configured to periodically sample the received signal according to the RE pattern and time-period.

The configuration information may comprise, for example, a frame number, a slot number in a frame identified by the frame number, a frequency range/bandwidth, an orthogonal frequency division multiplexing (OFDM) symbol index, selected resource element(s) and/or a period, identified for example by index(es) of the resource element(s). For example, the UE 104 may be configured to sample K REs with index RE₁ . . . . RE_{K} of every p^{th} OFDM symbol starting from OFDM symbol N₁ in slot S₁ of frame F₁ over bandwidth B₁. The frame number and the slot number may indicate a slot where the sampling is configured to be started. The OFDM symbol index may indicate the OFDM symbol (e.g. within the slot identified by the slot index) where the sampling is configured to be started. The configuration information may comprise location and/or orientation of the user node, where the sampling is to be performed.

In an embodiment, the BS 102 may be configured to instruct the UE 104 to sample transmissions over several OFDM symbols periodically. In this case, the configuration information may comprise the frame number, the slot number, the OFDM symbol index, a number of OFDM symbols over which the sampling is to be performed, the bandwidth over which the sampling is requested to be performed, and/or a period. The period may comprise instructions to repeat the sampling in every P OFDM symbols, for example. Hence, the UE may be expected to sample M consecutive OFDM symbols with a period of P OFDM symbols (P>M) starting from OFDM symbol N₁ in slot S₁ of frame F₁ over bandwidth B₁.

In an embodiment, the BS 102 may be configured to instruct the UE 104 to sample transmission of physical downlink channel over several OFDM symbols when it reaches a certain location L₁ and 3D orientation O₁ along its trajectory. In this case, the configuration information may comprise the location, the number of OFDM symbols over which the sampling is to be performed, and/or the bandwidth over which the sampling is to be done.

The configuration information provided at 204 may comprise configuration of resources for reporting the sampled transmissions. The configuration may comprise, for example, UL bandwidth part, UL PRB (physical resource block) index to transmit the measurement report, at least one index of UL slot and/or at least one index of UL frame. The UE 104 may be configured to upload the measurements over the configured UL resources. The configuration information may further comprise a number of quantization bits for generating the measurement report, for example for compression of the samples before sending them to the BS 102. The configuration information may comprise a threshold value indicating if a sample from the sampled transmissions is to be included in the measurement report. The threshold may be with respect to amplitude or power of the received sample.

At 206, the UE 104 may be configured to acknowledge the configuration information to the BS 102.

At 208, the BS 102 may be configured to transmit the samples, for example, over the physical downlink shared channel. At 210, the UE 104 may perform sampling on transmissions of the PDSCH/PDCCH, based on the configuration information received at operation 204. The UE 104 may collect the samples for the configured physical time-frequency resources, i.e., sample the transmission of the physical downlink channel over the time-frequency resources. The UE 104 may be configured to store the samples.

To reduce the UL transmission overhead, the UE 104 may be configured to compress the sampled transmissions. In an embodiment, the UE 104 may be configured to compress the data with quantization. The UE 104 may be configured to quantize the sampled transmissions sample-by-sample. The overhead may be directly determined based on the number of quantization bits. Based on the parameter that is being estimated, the BS 102 may determine the number of the quantization bits for a sample and provide the number of the quantization bits in the configuration information at 204.

Instead of the sample-by-sample quantization, the compressing may be done by the UE 104 with vector quantization. In vector quantization, the quantizer does not operate sample by sample but on a vector of N REs on which the sampling is performed. Such a quantizer may provide improved performance in terms of quantization noise, but at a higher complexity than the sample-by-sample quantization.

In an embodiment, the quantized or bits the unquantized bits may be source coded. Hence, redundancy may be reduced.

In an embodiment, the BS 102 may be configured to instruct the UE 104 to sample from multiple sets of REs. The UE 104 may be configured to analyze each set of REs (or OFDM symbols) and transmit only the ones that the UE 104 determines are useful. For example, the UE 104 may only transmit sets where signal-to-noise ratio (SNR) exceeds a predetermined threshold. The predetermined threshold may be determined by the BS 102. For example, the predetermined threshold for the SNR may be set by the BS 102 for the sampled transmissions in the configuration information at 204. Instead of SNR, the BS 102 may configure a threshold value for any other quantity.

In an embodiment, the compression may be performed by combining multiple received samples. For example, the BS 102 may be configured to instruct the UE 104 to transmit the sum of a group of samples. For example, the samples may be transmitted with a PDSCH transmission with quadrature phase-shift keying (QPSK) modulation. Since the BS 102 knows the symbols that are transmitted, the BS 102 may be configured to request the UE 104 to combine received symbols that correspond to the same transmitted symbols. For example, if the received observations are r₁, r₂, r₃ and r₄ the BS 102 may request the UE 104 to report r₁+r₃ and r₂+r₄ instead of the all the four received observations. Hence, the BS 102 knows that the same symbols are transmitted in r₁ and r₃ and r₂ and r₄, respectively.

At 212, the UE 104 may generate and transmit a measurement report comprising samples of the transmissions sampled at operation 210. The UE 104 is configured to forward the quantized and compressed samples to the BS 102. Generating the labelled training data for the radio-aware DT is relatively latency insensitive. In other words, the measurement report may be received at the network several seconds or minutes (depending on how fast the propagation environment changes) later. In an embodiment, the samples may be forwarded along with the location and 3D orientation of the UE 104, associated with the time of the sampling. Since the transmission may not be latency sensitive, the UE 104 may transmit the samples as enhanced mobile broadband (eMBB) traffic instead of as ultra-reliable low-latency communication (URLLC) traffic, for example. When the number of received samples is large, the transmission can also happen at a higher modulation and coding scheme because of longer-length codewords.

The UE 104 may be configured to wait (or the trajectory may be modified) such that the measurement report may be uploaded to the BS 102 at an extremely high data rate. In an embodiment, the UE 104 may be configured to wait so that it is in an area with good coverage from the BS 102 when transmitting the received samples. Hence, the transmission may happen with a high modulation and coding scheme. Instead of the wait, the trajectory of the UE 104 may be modified for the improved coverage. The trajectory of the UE 104 may be modified, for example, by the DT 200 or the BS 102. The UE 104 may transmit the measurement report based at least on location of the UE 104 in the radio access network and/or radio condition(s) of the radio access network.

In an embodiment, the network may comprise multiple dedicated APs with a short coverage area and relatively huge bandwidth, for example, at mmWave or THz frequencies. The dedicated APs may be installed in an area associated with the network to be modelled. The area may comprise, for example, a factory site. The UE 104 may store the sampled transmissions until it is in the vicinity of the dedicated APs and then offload large amounts of sampled transmissions.

In an embodiment, the UL transmissions may be scheduled or initiated by the DT 200 or the BS 102 such that the samples are sent when network traffic is low.

The network, such as the BS 102, may know both the desired and the interfering DL signal that was transmitted on the REs. In other words, the DL transmitted samples are already available at the network. Given this information, the network may obtain channel estimates of both the desired and the interfering channels. Since both the data and the channel estimates are available, the network may be configured to compute UL/DL SINR, channel statistics, or any other parameter that is required to train the radio-aware DT and update an associated REM database. At 214, the BS 102 may be configured to provide labelled training data to the radio-aware digital twin 200 based on the samples received from the UE 104. The labelled training data may comprise one or more parameters determined by the BS 102 based on the transmitted and received samples.

For example, the UE 104 may be a single antenna UE receiving payload data in the DL. Alternatively, the UE 104 may be a multi-antenna UE. The network may have, for example, a total of L cells. The UE 104 may be connected to a single serving cell and there may be L−1 cells interfering with the UE. There may be more than L−1 interfering cells in the network, but interference from only L−1 of them may be above noise floor.

Hence, n^{th} symbol received at the UE 104 may be written as:

$${y}_{n} = {\sum }_{l = 1}^{L} {h}_{l} {x}_{ln} + {w}_{n} = {x}_{n}^{T} h + {w}_{n}$$

where hₗ is the channel between the l^{th} BS and the UE, and xₗₙ is the n^{th} symbol transmitted by BS l. wₙ is the additive white Gaussian noise at the UE 104. It may be denoted xₙ=[x₁ₙ, . . . , x_{Ln}]^{T} and h=[h₁, . . . , h_{L}]^{T}. It may be assumed a block fading model, where the channel remains approximately fixed within the coherent block.

By aggregating P≥L observations in the coherence block y=[y₁, . . . , yₚ]^{T}, it may be obtained y=Xh+w at the UE, where X=[x₁, . . . , xₚ]^{T}.

Once the UE 104 sends y back to the BS 102 in the UL, the BS 102 may recover h by multiplying y by X⁺, where A⁺ denotes the Moore-Penrose pseudo inverse of A. Since X is a random matrix with entries coming from a QAM constellation, it may have full column rank with a high probability.

With a multi-antenna BS configured to have M antennas and to use a precoding vector pₗ, the channel value hₗ seen at the UE 104 is the effective channel and is an inner product of the channel vector \tilde{h}ₗ and the precoding vector pₗ. Specifically,

$${h}_{l} = {\tilde{h}}_{l}^{T} {p}_{l} ,$$

where \tilde{h}ₗ=[hₗ₁, . . . , h_{lM}]^{T} and hₗₘ is the channel value between the UE 104 and antenna m of BS l. In this case, the BS 102 can estimate the ‘effective channel’ hₗ based on the method above.

At 216, the digital twin 200 may use the labelled training data provided by the BS 102 to train a machine-learning model of the radio-propagation environment. In addition, the data may be used to update the REM database.

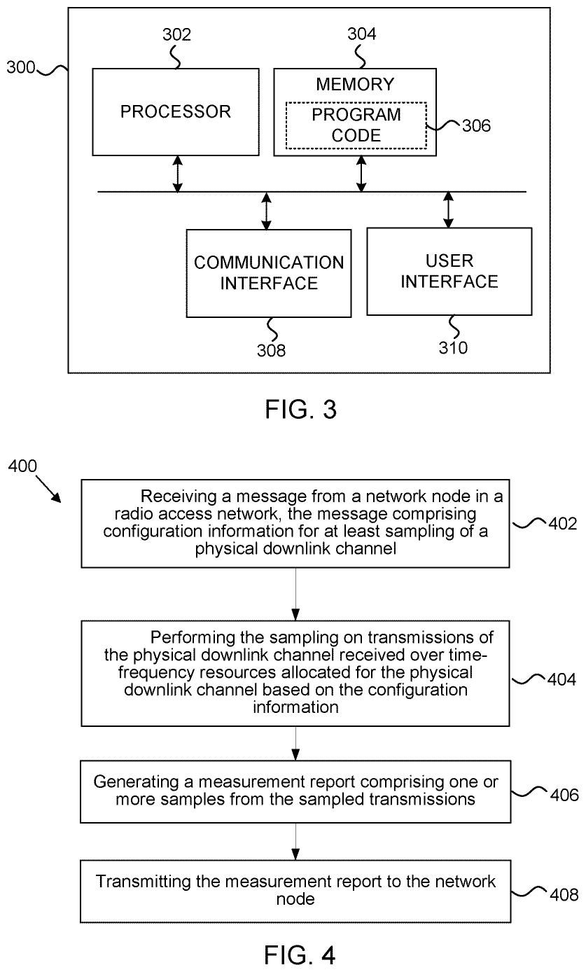

FIG. 3 illustrates an example of an apparatus 300 configured to practice one or more example embodiments.

The apparatus 300 may comprise at least one processor 302. The at least one processor 302 may comprise, for example, one or more of various processing devices, such as for example a co-processor, a microprocessor, a controller, a digital signal processor (DSP), a processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, or the like.

The apparatus 300 may further comprise at least one memory 304. The memory 304 may be configured to store, for example, computer program code 306 or the like, for example operating system software and application software. The memory 304 may comprise one or more volatile memory devices, one or more non-volatile memory devices, and/or a combination thereof. For example, the memory 304 may be embodied as magnetic storage devices (such as hard disk drives, magnetic tapes, etc.), optical magnetic storage devices, or semiconductor memories (such as mask ROM, PROM (programmable ROM), EPROM (erasable PROM), flash ROM, RAM (random access memory), etc.).

The apparatus 300 may further comprise one or more communication interfaces 308 configured to enable apparatus 300 to transmit and/or receive information, to/from other apparatuses. The communication interface 308 may be configured to provide at least one wireless radio connection, such as for example a 3GPP mobile broadband connection (e.g. 3G, 4G, 5G). However, the communication interface 308 may be configured to provide one or more other type of connections, for example a wireless local area network (WLAN) connection such as for example standardized by IEEE 802.11 series or Wi-Fi alliance; a short range wireless network connection such as for example a Bluetooth, NFC (near-field communication), or RFID connection;

a wired connection such as for example a local area network (LAN) connection, a universal serial bus (USB) connection or an optical network connection, or the like; or a wired Internet connection. The communication interface 308 may comprise, or be configured to be coupled to, at least one antenna to transmit and/or receive radio frequency signals. One or more of the various types of connections may be also implemented as separate communication interfaces, which may be coupled or configured to be coupled to a plurality of antennas.

The apparatus 300 may further comprise a user interface 310 comprising an input device and/or an output device. The input device may take various forms such a keyboard, a touch screen, or one or more embedded control buttons. The output device may for example comprise a display, a speaker, a vibration motor, or the like.

When the apparatus 300 is configured to implement some functionality, some component and/or components of the apparatus 300, such as for example the at least one processor 302 and/or the memory 304, may be configured to implement this functionality. Furthermore, when the at least one processor 302 is configured to implement some functionality, this functionality may be implemented using program code 306 comprised, for example, in the memory 304.

The functionality described herein may be performed, at least in part, by one or more computer program product components such as software components. According to an embodiment, the apparatus 300 comprises a processor or processor circuitry, such as for example a microcontroller, configured by the program code when executed to execute the embodiments of the operations and functionality described. Alternatively, or in addition, the functionality described herein can be performed, at least in part, by one or more hardware logic components. For example, and without limitation, illustrative types of hardware logic components that can be used include Field-programmable Gate Arrays (FPGAs), application-specific Integrated Circuits (ASICs), application-specific Standard Products (ASSPs), System-on-a-chip systems (SOCs), Complex Programmable Logic Devices (CPLDs), Graphics Processing Units (GPUs).

The apparatus 300 comprises means for performing at least one method described herein. In one example, the means comprises the at least one processor 302, the at least one memory 304 including program code 306 configured to, when executed by the at least one processor 302, cause the apparatus 300 to perform the method.

The apparatus 300 may comprise for example a computing device such as for example a base station, a network node, a server device, a client node, a mobile phone, a tablet computer, a laptop, an internet of things (IoT) device, or the like. In one example, the apparatus 300 may comprise a vehicle such as for example an unmanned aerial vehicle. In an embodiment, the computing device may be configured to store and/or run an application providing a digital twin of a radio-propagation environment. Although the apparatus 300 is illustrated as a single device it is appreciated that, wherever applicable, functions of apparatus 300 may be distributed to a plurality of devices. For example, the apparatus 300 may be distributed to a plurality of devices to implement example embodiments as a cloud computing service.

FIG. 4 illustrates an example of a flow chart of a method 400 for performing measurements by a user node to train a digital twin, according to an example embodiment.

At 402, the method may comprise receiving a message from a network node in a radio access network, the message comprising configuration information for at least sampling of a physical downlink channel. The user node may receive configuration information from a network node for performing sampling on transmissions of a physical downlink channel received over physical time-frequency resources. The physical time-frequency resources may be OFDM symbols or subcarriers within the OFDM symbols. The smallest physical time-frequency resource may comprise one subcarrier in one OFDM symbol, known as a resource element.

According to an example embodiment, the method may comprise instructing, by a network node, the user node with a location of certain resource elements (REs) in time and frequency allocated for a physical downlink shared channel or (PDSCH) physical downlink control channel (PDCCH) over the which sampling is to be made. The method may also comprise instructing, by a network node, the user node with the physical location and 3D orientation of the user node where the sampling need to be made.

At 404, the method may comprise performing the sampling on transmissions of the physical downlink channel received over time-frequency resources allocated for the physical downlink channel on based the configuration information. The user node may sample transmissions received over the physical downlink channel based on the configuration. The samples may be stored at the user node. The method may further comprise compressing the samples, that is to be sent from the UE to the network. The user node may, for example, quantize the received samples in the REs.

At 406, the method may comprise generating a measurement report comprising one or more samples from the sampled transmissions.

At 408, the method may comprise transmitting the measurement report to the network node. The user node may send one or more samples to the network node over a physical uplink channel, such as a physical uplink shared channel (PUSCH). In an embodiment, the configuration information may comprise instructions for reporting the samples over the physical uplink channel.

In an embodiment, the user node may be configured to wait until the user node is within an area of good coverage from the network node before sending the samples. In an embodiment, the user node may be configured to wait until it is in vicinity of a dedicated low-range high-bandwidth access point before sending the samples to the network node. In an embodiment, the UE 104 may send, along with the samples, the 3D location and orientation of the UE 104 when the sampling was made to the network node.

In an embodiment, the user node may be configured to change its trajectory to arrive at the area of good coverage or coverage area of the dedicated access point, or a location indicated by the BS 120 for performing the sampling. In an embodiment, the user node may be configured to wait until network traffic is low before sending the samples to the network node. In an embodiment, the user node may be configured to compress the samples before sending them to the network node. The compression may be performed based on instructions received from the network node in the configuration information. In an embodiment, UE 104 may determine its location and/or orientation during the sampling and include an indication indicative of the determined location and/or orientation in the measurement report. This may be in response to receiving, from BS 102, a request the do so, for example as part of the configuration information of operation 204.

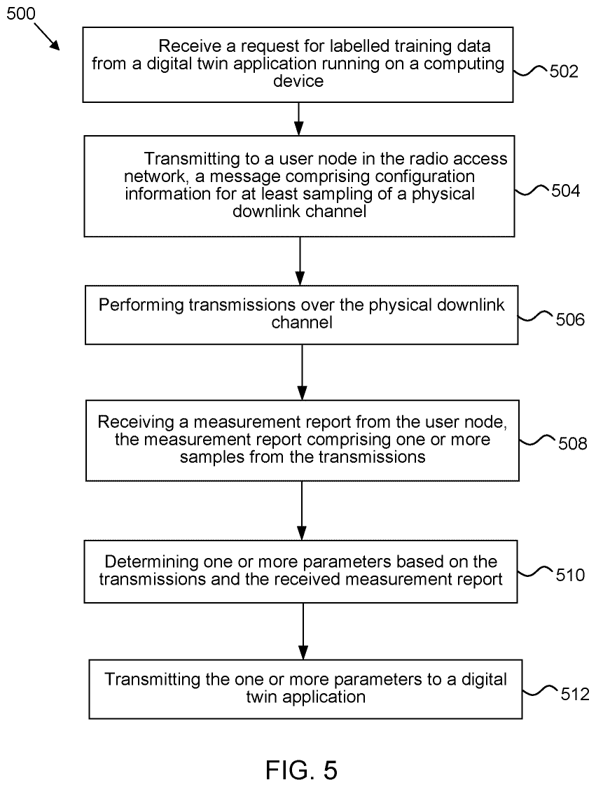

FIG. 5 illustrates an example of a flow chart of a method 500 for obtaining measurement report by a network node to train a digital twin according to an example embodiment.

At 502, the method may comprise receiving a request for labelled training data from a digital twin. The digital twin may comprise an application running on a computing device, such as a network node. Operation 502 may be optional.

At 504, the method may comprise transmitting to a user node in the radio access network, a message comprising configuration information for at least sampling of a physical downlink channel. The network node may configure a user node for performing sampling on transmissions of a physical downlink channel received over physical time-frequency resources. The network node may be configured to send configuration information to the user node in response to the request received from the digital twin application.

At 506, the method may comprise performing transmissions over the physical downlink channel. The network node may for example transmit data over the physical downlink channel to the user node.

At 508, the method may comprise receiving a measurement report from the user node, the measurement report comprising one or more samples from the transmissions. The network node may receive from the user node over the physical uplink channel one or more samples of the sampled transmissions along with the 3D location and orientation of the UE when the sampling was made.

At 510, the method may comprise determining one or more parameters based on the transmissions and the received measurement report. The network node may determine the one or more parameters for training a machine learning model of a radio-propagation environment modelled by the digital twin application. The one or more parameters may be determined based on the data transmitted by the network node and the samples measured by the user node. The parameters may comprise, for example, UL/DL SINR or channel statistics. The method may further comprise obtaining the channel state information at the network from the user node measurement report.

At 512, the method may comprise transmitting the one or more parameters to a digital twin application. The network node may be configured to send the parameters as labelled training data to the digital twin application.

Further features of the methods directly result from the functionalities and parameters of the apparatuses, such as network nodes and user nodes, as described in the appended claims and throughout the specification and are therefore not repeated here. It is noted that one or more operations of the method may be performed in different order.

An apparatus, for example a network node, a user node or a client node, may be configured to perform or cause performance of any aspect of the method(s) described herein. Further, a computer program may comprise instructions for causing, when executed, an apparatus to perform any aspect of the method(s) described herein. Further, an apparatus may comprise means for performing any aspect of the method(s) described herein. According to an example embodiment, the means comprises at least one processor, and memory including program code, the at one memory and the program code configured to, when executed by the at least one processor, cause performance of any aspect of the method(s).

Any range or device value given herein may be extended or altered without losing the effect sought. Also, any embodiment another embodiment unless explicitly may be combined with disallowed.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item may refer to one or more of those items.

The operations of the methods described herein may be carried out in any suitable order, or simultaneously where appropriate. Additionally, individual blocks may be deleted from any of the methods without departing from the scope of the subject matter described herein. Aspects of any of the embodiments described above may be combined with aspects of any of the other embodiments described to form further embodiments without losing the effect sought.

The term ‘comprising’ is used herein to mean including the method, blocks, or elements identified, but that such blocks or elements do not comprise an exclusive list and a method or apparatus may contain additional blocks or elements.

As used in this application, the term ‘circuitry’ may refer to one or more or all of the following: (a) hardware-only circuit implementations (such as implementations in only analog and/or digital circuitry) and (b) combinations of hardware circuits and software, such as (as applicable): (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions) and (c) hardware circuit(s) and or processor(s), such as a microprocessor(s) or a portion of a microprocessor(s), that requires software (e.g., firmware) for operation, but the software may not be present when it is not needed for operation. This definition of circuitry applies to all uses of this term in this application, including in any claims.

As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from scope of this specification.

1.-23. (canceled)

24. A user node in a radio access network, comprising:
at least one processor; and
at least one memory including computer program code;
the at least one memory and the computer code configured to, with the at least one processor, cause the user node at least to:
based on a request for labelled training data from a digital twin, receive a message from a network node in the radio access network, the message comprising configuration information for at least sampling of a physical downlink channel, wherein the configuration information comprises: a frame number and a slot number in the frame number, the frame number and the slot number indicating a slot where the sampling starts, an index of an orthogonal frequency division multiplexing (OFDM) symbol from which the sampling is started in the slot and an index of one or more resource elements over which the sampling is to be performed, a number of OFDM symbols over which the sampling is to be performed, frequency range or bandwidth over which the sampling is to be performed, a location and orientation of the user node where the sampling is to be performed, an allocation of uplink resources over a physical uplink channel for the user node to send the measurement report to the network node, the allocation of uplink resources comprising an uplink bandwidth part, an uplink physical resource block index, an index of an uplink slot, and an index of an uplink frame, wherein the configuration information further comprises a threshold value indicating if a sample from the sampled transmissions is to be comprised in the measurement report;
perform the sampling on transmissions of the physical downlink channel received over time-frequency resources allocated for the physical downlink channel based on the configuration information; and
generate a measurement report comprising samples from the sampled transmissions, wherein the generating the measurement report comprises: quantizing the samples, source-coding the samples, selecting the samples based on the threshold value, and combining the samples; and
transmit the measurement report to the network node to provide labelled training data for the digital twin based on the samples.

25. The user node of claim 24, wherein the at least one memory and the computer code configured to, with the at least one processor, cause the user node further to:
store the one or more samples from the sampled transmissions.

26. The user node of claim 25, wherein the configuration information further comprises a period for repeating the sampling.

27. The user node of claim 26, wherein the configuration information further comprises a number of quantization bits for generating the measurement report.

28. The user node of claim 27, wherein the at least one memory and the computer code are further configured to, with the at least one processor, cause the user node to:
transmit the measurement report based at least on location of the user node in the radio access network and radio condition of the radio access network.

29. The user node of claim 28, wherein the at least one memory and the computer code are further configured to, with the at least one processor, cause the user node to:
modify trajectory to arrive within an area with good coverage from the network node or a location set by the network node for performing the sampling.

30. The user node of claim 28, wherein the at least one memory and the computer code are further configured to, with the at least one processor, cause the user node to:
modify trajectory to arrive within an area of coverage of a dedicated access point.

31. A network node in a radio access network, comprising:
at least one processor; and
at least one memory including computer program code;
the at least one memory and the computer code configured to, with the at least one processor, cause the network node at least to:
receive a request for labelled training data for a digital twin application;
based on the request for labelled training data for the digital twin, transmit a message to a user node in the radio access network, the message comprising configuration information for at least sampling of a physical downlink channel, wherein the configuration information comprises: a frame number and a slot number in the frame number, the frame number and the slot number indicating a slot where the sampling starts, an index of an orthogonal frequency division multiplexing (OFDM) symbol from which the sampling is started in the slot and an index of one or more resource elements over which the sampling is to be performed, a number of OFDM symbols over which the sampling is to be performed, frequency range or bandwidth over which the sampling is to be performed, a location and orientation of the user node where the sampling is to be performed, an allocation of uplink resources over a physical uplink channel for the user node to send the measurement report to the network node, the allocation of uplink resources comprising an uplink bandwidth part, an uplink physical resource block index, an index of an uplink slot, and an index of an uplink frame, wherein the configuration information further comprises a threshold value indicating if a sample from sampled transmissions is to be comprised in the measurement report;
performing transmissions over the physical downlink channel to the user node;
receive, a measurement report generated by the user node, the measurement report comprising samples from transmissions sampled by the user node, and wherein the measurement report is generated by quantizing the samples, source-coding the samples, selecting the samples based on the threshold value, and combining the samples; and
transmit the measurement report to the network node to provide labelled training data for the digital twin based on the samples.

32. The network node of claim 31, wherein the configuration information further comprises a period for repeating the sampling.

33. The network node of claim 32, wherein the configuration information further comprises a number of quantization bits for generating the measurement report.

34. The network node of claim 33, wherein the measurement report further comprises an indication indicative of a location of the user node.

35. The network node of claim 34, wherein the measurement report further comprises an indication indicative of an orientation of the user node.

36. The network node of claim 35, wherein the one or more parameters are further determined for training a machine learning model of a radio-propagation environment modelled by the digital twin application.

37. The network node of claim 36, wherein the one or more parameters comprise channel statistics.

38. A method comprising:
receiving, by a network node, a request for labelled training data for a digital twin application;
based on the received request, transmitting, from the network node to a user node in the radio access network, a message comprising configuration information for at least sampling of a physical downlink channel configuration information for at least sampling of a physical downlink channel, wherein the configuration information comprises: a frame number and a slot number in the frame number, the frame number and the slot number indicating a slot where the sampling starts, an index of an orthogonal frequency division multiplexing (OFDM) symbol from which the sampling is started in the slot and an index of one or more resource elements over which the sampling is to be performed, a number of OFDM symbols over which the sampling is to be performed, frequency range or bandwidth over which the sampling is to be performed, a location and orientation of the user node where the sampling is to be performed, an allocation of uplink resources over a physical uplink channel for the user node to send the measurement report to the network node, the allocation of uplink resources comprising an uplink bandwidth part, an uplink physical resource block index, an index of an uplink slot, and an index of an uplink frame, wherein the configuration information further comprises a threshold value indicating if a sample from sampled transmissions is to be comprised in the measurement report;
performing, by the network node, transmissions over the physical downlink channel to the user node;
performing, by the user node, the sampling on transmissions of the physical downlink channel received over time-frequency resources allocated for the physical downlink channel based on the configuration information;
generate, by the user node, a measurement report comprising samples from the sampled transmissions, wherein the generating the measurement report comprises: quantizing the samples, source-coding the samples, selecting the samples based on the threshold value, and combining the samples;
determining, by the network node, one or more parameters based on the transmissions and the received measurement report; and
transmit the one or more parameters as the labelled training data to the digital twin application.

39. The method of claim 38, wherein the configuration information further comprises a period for repeating the sampling.

40. The method of claim 39, wherein the configuration information further comprises a number of quantization bits for generating the measurement report.

41. The method of claim 40, further comprising transmitting the measurement report based at least on location of the user node in the radio access network and radio condition of the radio access network.

42. The method of claim 41, further comprising modifying trajectory to arrive within an area with good coverage from the network node.

43. The method of claim 41, further comprising modifying trajectory to arrive within a location set by the network node for performing the sampling.
